(19) United States
(12) Patent Application Publication
(10) Pub. No.: US 2024/0025334 A1
(43) Pub. Date: Jan. 25, 2024

(54) SYSTEM AND METHOD FOR NOTIFYING DECELERATION OF A VEHICLE

(71) Applicant: GyroStop LLC, Dallas, GA (US)

(72) Inventors: Michael Wayne Kerlin, Dallas, GA (US); Dalton Ray Willis, Douglasville, GA (US)

(73) Assignee: GyroStop LLC, Dallas, GA (US)

(21) Appl. No.: 17/813,528

(22) Filed: Jul. 19, 2022

(51) Int. Cl. B60Q 1/44; B60Q 1/50; B60Q 1/00

(52) U.S. Cl. CPC B60Q 1/444; B60Q 1/535; B60Q 1/0041

(57) ABSTRACT

A vehicle deceleration notification system includes a deceleration sensor installed in a vehicle. The deceleration sensor measures a magnitude of vehicle deceleration. The vehicle deceleration notification system further includes a vehicle display unit installed at a rear end of the vehicle. The vehicle display unit is a linearly oriented and double mirrored display unit having a plurality of light sources. The vehicle deceleration notification system further includes a processor that obtains the magnitude of vehicle deceleration from the deceleration sensor and determines a preset deceleration range, of a plurality of preset deceleration ranges, associated with the magnitude of vehicle deceleration. The processor further selects a display mode of the vehicle display unit based on the determination of the associated preset deceleration range and actuates the selected display mode of the vehicle display unit.

### TECHNICAL FIELD

The present disclosure relates to a system and method for notifying deceleration of a vehicle to trailing vehicles, and more specifically to generating a dynamic output of vehicle braking deceleration that notifies the extent of deceleration to trailing vehicles, even when brake pedal of the vehicle is not depressed.

### BACKGROUND

Typically, most modern vehicles have a brake warning system that includes brake warning lights installed at the rear end of the vehicle. The brake warning system provides visual notification or signal to a trailing vehicle when an operator of the vehicle depresses the brake pedal. The notification helps the operator of the trailing vehicle to take appropriate action to stop or slow his vehicle. In particular, the brake warning lights illuminate when the operator depresses the brake pedal, and they extinguish when the operator releases the brake pedal. In autonomous vehicles and vehicles with cruise control system, the brake warning lights illuminate when the autonomous braking system or the emergency braking system activates, and the brake warning lights extinguish when the braking system deactivates.

While the conventional brake warning system, as mentioned above, provides an indication of deceleration of the vehicle when the operator depresses the brake pedal, it does not work when the brake pedal is not depressed or when the autonomous braking system is not activated. For example, when the vehicle is plying on a wet road, or is being driven on an off-road terrain, the vehicle may decelerate even when the operator does not apply the brakes. In such situations, the conventional brake warning system does not activate when the brake pedal is not depressed. Thus, the brake warning lights remain off, giving the operator of the trailing vehicle no indication regarding the deceleration maneuver that is taking place in the vehicle in the front. Due to this, the operator of the trailing vehicle may not get timely warning signal to stop or slow his vehicle. Moreover, conventional brake warning systems do not provide a visual indication to trailing vehicles of the magnitude of vehicle braking.

Further, most of the Electric Vehicles (EVs) have regenerative braking system designed into the vehicle that recharges the batteries when the operator releases the vehicle's accelerator. This causes the vehicle to decelerate without the brakes being applied, at a rate more than a typical rate of deceleration for a non-electric vehicle when the operator releases the accelerator. This increased rate of deceleration is not notified to the operator of the trailing vehicle in the conventional brake warning system.

Thus, there is a need for a system and method for accurately measuring deceleration of a vehicle and notifying the deceleration to the trailing vehicle.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a conventional brake warning system.

FIG. 2 depicts an exemplary vehicle display unit in accordance with the present disclosure.

FIG. 3 illustrates operation of the vehicle display unit in accordance with the present disclosure.

FIG. 4a depicts an exemplary embodiment of installation of the vehicle display unit in accordance with the present disclosure located on the rear bumper.

FIG. 4b depicts an exemplary embodiment of installation of the vehicle display unit in accordance with the present disclosure located on the rear of the roof.

FIG. 4c depicts an exemplary embodiment of installation of the vehicle display unit in accordance with the present disclosure located on a tailgate.

FIG. 4d depicts an exemplary embodiment of installation of the vehicle display unit in accordance with the present disclosure located on the rear window glass.

FIG. 5 depicts a flow diagram of an example method for notifying deceleration of a vehicle in accordance with the present disclosure.

FIG. 6 depicts a block diagram of a vehicle deceleration notification system in accordance with the present disclosure.

### DETAILED DESCRIPTION

### Overview

The present disclosure is directed towards a method for notifying deceleration of a vehicle. The method includes obtaining, via a processor of a vehicle deceleration notification system, magnitude of vehicle deceleration. The method further includes determining, via the processor, a preset deceleration range, of a plurality of preset deceleration ranges, associated with the magnitude of vehicle deceleration. Based on the determination, the method may include selecting, via the processor, a display mode of a plurality of display modes, of a vehicle display unit installed at the rear end of the vehicle.

In some aspects, the vehicle display unit may be and/or include a linearly oriented and double mirrored display unit having a plurality of light sources.

In one or more embodiments, the method can further include actuating, via the processor, the selected display mode of the vehicle display unit. The plurality of display modes can include a first display mode. In some aspects, in the first display mode the plurality of light sources progressively illuminates, from the outer ends of the vehicle display unit to the center of the vehicle display unit, proportional to the magnitude of vehicle deceleration. In some aspects, the processor may cause the display unit to actuate when the magnitude of vehicle deceleration is in a first preset deceleration range of the plurality of preset deceleration ranges.

The plurality of display modes may further include a second display mode. The processor may cause the vehicle display unit to actuate the plurality of light sources and maintain complete illumination in the second display mode. The processor may actuate the second display mode when the magnitude of vehicle deceleration increases beyond the first preset deceleration range and is in a second preset deceleration range of the plurality of preset deceleration ranges.

In one or more embodiments, the plurality of display modes further includes a third display mode. In some aspects, the processor may cause the plurality of light sources to actuate to simultaneously illuminate and maintain the complete illumination for a predetermined time duration in the third display mode. The processor may actuate the third display mode when the magnitude of vehicle deceleration reaches a third preset deceleration range, and a rate of change of deceleration is greater than a predefined threshold.

In accordance with further embodiment of the present disclosure, the vehicle display unit may be disposed on a vehicle between factory installed brake lights of the vehicle.

In accordance with further embodiment of the present disclosure, the system may cause the vehicle display unit to output an illumination having a luminous magnitude approximately equivalent to an illumination level of the factory installed brake lights.

In accordance with further embodiment of the present disclosure, the vehicle display unit functions independent of the factory installed brake lights.

In accordance with further embodiment of the present disclosure, the processor may progressively extinguish the illumination of the plurality of light sources as the magnitude of vehicle deceleration decreases. The illumination of the light sources extinguishes completely as a magnitude of vehicle velocity approaches zero. In some aspects, the factory installed brake lights may function normally according to utilization of vehicle brakes, while the system causes a diminishing illumination effect as the rate of vehicle velocity changes (decreases). As the vehicle comes to a stop, the vehicle factory installed brake lights may illuminate normally, while the system causes the illumination effect to decrease to a non-illuminated state as the vehicle slows to a stop.

In accordance with further embodiment of the present disclosure, the processor may switch between the first display mode, the second display mode, and the third display mode, based on the change in the magnitude of the deceleration.

In accordance with further embodiment of the present disclosure, the plurality of display modes may include a fourth display mode. The processor may actuate the plurality of light sources to progressively illuminate in one or more cycles repeatedly in the fourth display mode. A cycle of illumination may start from illumination of the light sources at the outer ends to the center, and end when all light sources of the plurality of light sources extinguish progressively from the center to the outer ends. In some aspects, the processor actuates the fourth display mode when the magnitude of vehicle deceleration is in a fourth preset deceleration range, and the fourth preset deceleration range is greater than the second preset deceleration range.

The present disclosure is further directed towards a vehicle deceleration notification system. The vehicle deceleration notification system may include a deceleration sensor installed in a vehicle. The deceleration sensor is configured to measure magnitude of vehicle deceleration. The vehicle deceleration notification system may further include a vehicle display unit installed at the rear end of the vehicle.

In some aspects, the vehicle display unit may be and/or include a linearly oriented and double mirrored display unit having a plurality of light sources.

In one or more embodiment, the vehicle deceleration notification system may further include a processor. The processor may communicate with the deceleration sensor and the vehicle display unit.

In some aspects, the processor may obtain the magnitude of vehicle deceleration from the deceleration sensor and determine a preset deceleration range of a plurality of preset deceleration ranges associated with the magnitude of vehicle deceleration. In response to determining the preset deceleration range, the processor may select a display mode of a plurality of display modes of the vehicle display unit and actuate the selected display mode.

In some aspects, the plurality of display modes can include a first display mode. The plurality of light sources progressively illuminates, from the outer ends of the vehicle display unit to the center of the vehicle display unit, proportional to the magnitude of vehicle deceleration. The processor may actuate the first display mode when the magnitude of vehicle deceleration is in a first preset deceleration range of the plurality of preset deceleration ranges.

In one or more embodiments, the plurality of display modes may further include a second display mode. The plurality of light sources maintains complete illumination in the second display mode. In some aspects, processor may actuate the second display mode when the magnitude of vehicle deceleration increases beyond the first preset deceleration range and is in a second preset deceleration range of the plurality of preset deceleration ranges.

The plurality of display modes may further include a third display mode. The plurality of light sources simultaneously illuminates and maintain the complete illumination for a predetermined time duration in the third display mode. In some aspects, the processor may actuate the third display mode when the magnitude of vehicle deceleration reaches a third preset deceleration range, and a rate of change of deceleration is greater than a predefined threshold.

In accordance with further embodiment of the present disclosure, the vehicle display unit may be disposed on a vehicle between factory installed brake lights of the vehicle.

In accordance with further embodiment of the present disclosure, the processor may cause the vehicle display unit to output illumination having a luminous magnitude approximately equivalent to an illumination level of the factory installed brake lights.

In accordance with further embodiment of the present disclosure, the vehicle display unit functions independent of the factory installed brake lights.

In accordance with further embodiment of the present disclosure, the processor may progressively extinguish the illumination of the plurality of light sources as the magnitude of vehicle deceleration decreases. The illumination of the light sources extinguishes completely as the magnitude of vehicle deceleration reaches zero.

In accordance with further embodiment of the present disclosure, the processor may switch between the first display mode, the second display mode, and the third display mode, based on the change in the magnitude of the deceleration.

In accordance with further embodiment of the present disclosure, the plurality of display modes may include a fourth display mode. The processor may actuate the plurality of light sources to progressively illuminate in one or more cycles repeatedly in the fourth display mode. A cycle of illumination may start from illumination of the light sources at the outer ends to the center, and end when all light sources of the plurality of light sources extinguish progressively from the center to the outer ends. In some aspects, the processor actuates the fourth display mode when the magnitude of vehicle deceleration is in a fourth preset deceleration range, and the fourth preset deceleration range is greater than the second preset deceleration range.

The present disclosure is further directed towards a non-transitory computer-readable storage medium having instructions stored thereupon which, when executed by a processor, cause the processor to obtain a magnitude of vehicle deceleration from a deceleration sensor and determine a preset deceleration range, of a plurality of preset deceleration ranges, associated with the magnitude of vehicle deceleration.

In response to determining the preset deceleration range, the processor may, select a display mode of a plurality of display modes, of a vehicle display unit, and actuate the selected display mode of the vehicle display unit.

In some aspects, the plurality of display modes may include a first display mode. The processor may actuate a plurality of light sources to progressively illuminate, from the outer ends of the vehicle display unit to the center, proportional to the magnitude of vehicle deceleration in the first display mode. The processor may actuate the first display mode when the magnitude of vehicle deceleration is in a first preset deceleration range of the plurality of preset deceleration ranges.

The plurality of display modes may include a second display mode. The processor may cause the vehicle display unit to actuate the plurality of light sources to maintain complete illumination in the second display mode. The processor may actuate the second display mode when the magnitude of vehicle deceleration increases beyond the first preset deceleration range and is in a second preset deceleration range of the plurality of preset deceleration ranges.

In one more embodiments, the plurality of display modes may further include a third display mode. In some aspects, the processor may cause the vehicle display unit to simultaneously illuminate the plurality of light sources and maintain the complete illumination for a predetermined time duration in the third display mode. The processor may actuate the third display mode when the magnitude of vehicle deceleration reaches a third preset deceleration range, and a rate of change of deceleration is greater than a predefined threshold.

### Illustrative Embodiments

The disclosure will be described more fully hereinafter with reference to the accompanying drawings, in which example embodiments of the disclosure are shown, and not intended to be limiting.

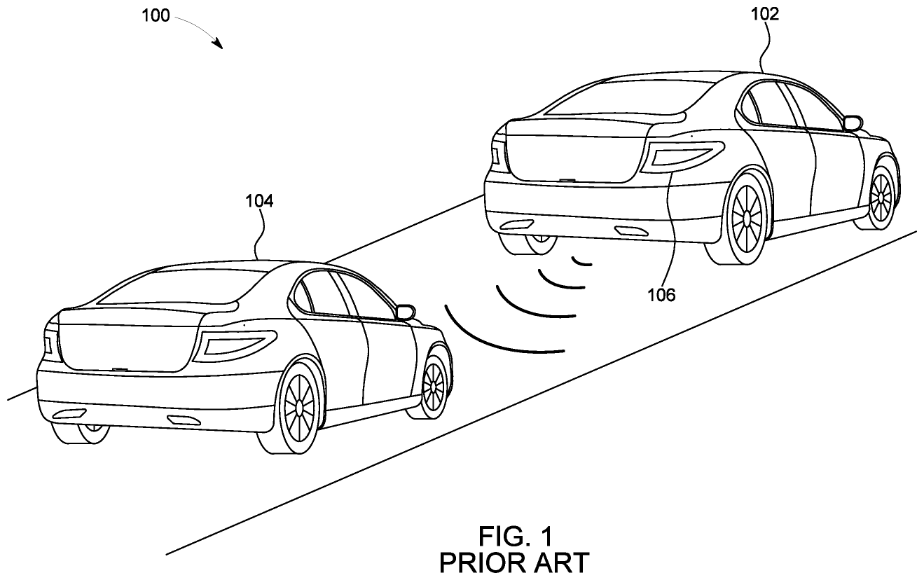

FIG. 1 depicts a conventional brake warning system 100. Specifically, FIG. 1 shows a first vehicle 102 and a second vehicle 104, which are travelling on a road. The first vehicle 102 and the second vehicle 104 may include a car, truck, jeep, bus, and the like. Typically, the first vehicle 102 decelerates when the operator of the first vehicle 102 depresses the brake pedal (not shown in FIG. 1) of the first vehicle 102. A processor (not shown in FIG. 1) installed in the first vehicle 102 may determine that the brake pedal is depressed by active communication and monitoring of the vehicle control units such as, for example, a vehicle braking system that controls vehicle braking. Responsive to determining that the brake pedal is depressed, the processor may command brake warning lights 106 installed at the rear end of the first vehicle 102 to illuminate. In case of autonomous vehicles or vehicles plying on cruise control, the processor may illuminate the brake warning lights 106 when the autonomous braking system of the first vehicle 102 is activated. The brake warning lights 106 may be factory installed rear taillights that include brake lights, turn lights, backup lights, etc., all bundled into a single lighting unit.

The illumination of the brake warning lights 106 provides an indication to the operator of the second vehicle 104 to take appropriate action, for example to stop or slow the second vehicle 104. The action could be, for example, quickly hitting the brakes hard when the first vehicle 102 is very close to the second vehicle 104 or applying brakes softly when the first vehicle 102 is far from the second vehicle 104. In other words, the illumination of the brake warning lights 106 acts as an indication of the deceleration of the first vehicle 102 when the operator depresses the brake pedal.

If the first vehicle 102 decelerates without the brake pedal being depressed, the brake warning lights 106 do not illuminate (and they remain in “OFF” mode). Examples of such situations may include, for example, regenerative braking as used in EVs, where the vehicle decelerates when the accelerator is released by the operator of the first vehicle 102, or when the operator of the first vehicle 102 is incapacitated, has lost consciousness, or is otherwise unable to operate the vehicle, or when the first vehicle 102 experiences a mechanical issue while in motion. In all these situations, in the conventional brake warning system 100 mentioned above, no notification or warning regarding the deceleration of the first vehicle 102 is given to the operator of the second vehicle 104, and hence the operator of the second vehicle 104 cannot take remedial actions.

In addition, in the conventional brake warning system 100, the brake warning lights 106 merely indicate whether the brake pedal is depressed or not, and not the extent to which the brake is applied. Thus, the extent of deceleration of the first vehicle 102 is not known to the operator of the second vehicle 104. Since the operator of the second vehicle 104 is unaware of the extent of deceleration of the first vehicle 102, the operator of the second vehicle 104 is unable to take appropriate action on time.

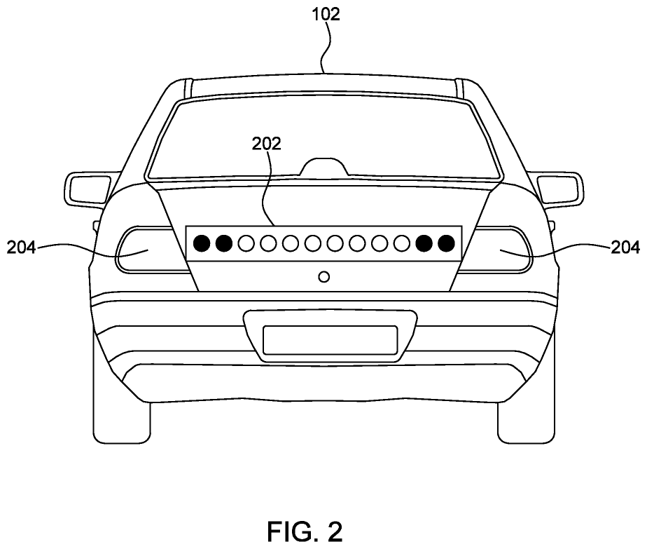

The system may provide accurate or correct indication (magnitude of vehicle deceleration) to the second vehicle 104. The present disclosure describes a vehicle deceleration notification system (described in FIG. 2) that may be installed in the first vehicle 102, that may be configured and/or controllable to operate independent from the brake system of the first vehicle 102. In other words, the vehicle deceleration notification system may be a fully autonomous system that operates independently from the brake warning lights 106 and augments the deceleration warning to the operator of the second vehicle 104. Thus, even when the operator of the first vehicle 102 does not depress the brake pedal or the autonomous braking system is not activated, the vehicle deceleration notification system can still provide an indication of deceleration of the first vehicle 102 to the second vehicle 104. The details of the vehicle deceleration notification system may be understood in conjunction with subsequent figures FIGS. 2-6.

FIG. 2 shows the vehicle deceleration notification system according to an embodiment of the present disclosure. The vehicle deceleration notification system may include a vehicle display unit 202 installed at the rear end of the first vehicle 102. Specifically, the vehicle display unit 202 may be located in between the conventional taillights 204 (such as the brake warning lights, turn signal, backup lights, etc.), and may cover the entire length of space or a portion of space between the taillights 204 as shown in FIG. 2. In accordance with another embodiment of the present disclosure, the vehicle display unit 202 may be mounted inside the rear window area of the first vehicle 102 or may be mounted horizontally or vertically in any area at the rear end of the first vehicle 102, making the vehicle display unit 202 clearly visible to the operator of the second vehicle 104.

In accordance with an embodiment of the present disclosure, a 12 Volt Direct Current (12 V DC) power system (not shown in FIG. 2) of the first vehicle 102 activates the vehicle display unit 202 by using a peripheral control cable, having no interlink with the factory brake light system of the first vehicle 102. This way, the vehicle display unit 202 works completely independently of the factory brake light system. Specifically, the 12 V DC power system activates the vehicle display unit 202 when the first vehicle 102 starts and deactivates it when the first vehicle 102 turns off Additionally, the vehicle display unit 202 may indicate the magnitude of the deceleration of the first vehicle 102, so that the operator of the second vehicle 104 can take appropriate action well in time.

It should be appreciated that, although described herein as a 12 V DC, embodiments of the present disclosure contemplate and may include other configurations for electric power supply including, for example, a 24 V DC power supply or the like.

In accordance with an embodiment of the present disclosure, the vehicle display unit 202 may include a plurality of light sources. The plurality of light sources may be light emitting diodes (LEDs). The plurality of light sources may be disposed in an array with equal distribution with respect to a vehicle centerline. For example, there are an equal count of lights on either side of the longitudinal centerline of the vehicle (centerline not shown in FIG. 2). For example, FIG. 2 depicts 12 LEDs in the vehicle display unit 202, where 6 lights are disposed on a left side and 6 lights are disposed on a right side.

In accordance with an embodiment of the present disclosure, the vehicle display unit 202 may be and/or include a linearly or horizontally oriented display, as shown in FIG. 2. In accordance with another embodiment of the present disclosure, the vehicle display unit 202 may be vertically oriented (not shown in FIG. 2), in an area at the rear end of the first vehicle 102. Furthermore, the vehicle display unit 202 may be a double mirrored display unit, so that it may present a double opposing linear mirrored image when the plurality of LEDs progressively illuminate.

In accordance with an embodiment of the present disclosure, the vehicle display unit 202 may be rectangular in shape that covers the length of space between the taillights 204, as mentioned above. Additionally, the plurality of LEDs of the vehicle display unit 202 may be circular in shape, as shown in FIG. 2. In accordance with another embodiment of the present disclosure, the vehicle display unit 202 may include the taillights 204 (such as brake warning lights, turn lights etc.) as well. In other words, the taillights 204 and the vehicle display unit 202 may be one/single unit that is installed at the rear end of the first vehicle I 02, but can still function independently.

The shapes of the vehicle display unit 202 and the LEDs, and the count of LEDs are provided for illustrative purposes only, and are not intended to be limiting or exclusive. The size, count and/or shape of the LEDs may vary based on the size of the vehicle display unit 202, and may also vary based on the type, design, size (width, height), etc. of the vehicle on which the vehicle display unit 202 is to be installed. Further, the vehicle display unit 202 is independent and weather-proof unit, which can work equally efficiently in all operating conditions of the first vehicle 102.

In accordance with further embodiment of the present disclosure, the vehicle display unit 202 may also include a graphic computerized screen that can display messages, signs or visual designs. In other words, the vehicle display unit 202 may not only include the plurality of LEDs, but may include other types of display means as well without departing from the scope of the present disclosure.

In an embodiment of the present disclosure, an illumination level of the vehicle display unit 202 has approximately the same luminous magnitude as an illumination level of the taillights 204. Also, the vehicle display unit 202 may not blink or flash, nor vary its color or change its luminosity. A person ordinarily skilled in the art may appreciate that such variations in light emission may cause distraction to the operator of the trailing vehicle. Also, the vehicle display unit 202 complies with the regulations of Department of Transportation (DOT), with respect to the luminosity of the light sources in the vehicle display unit 202.

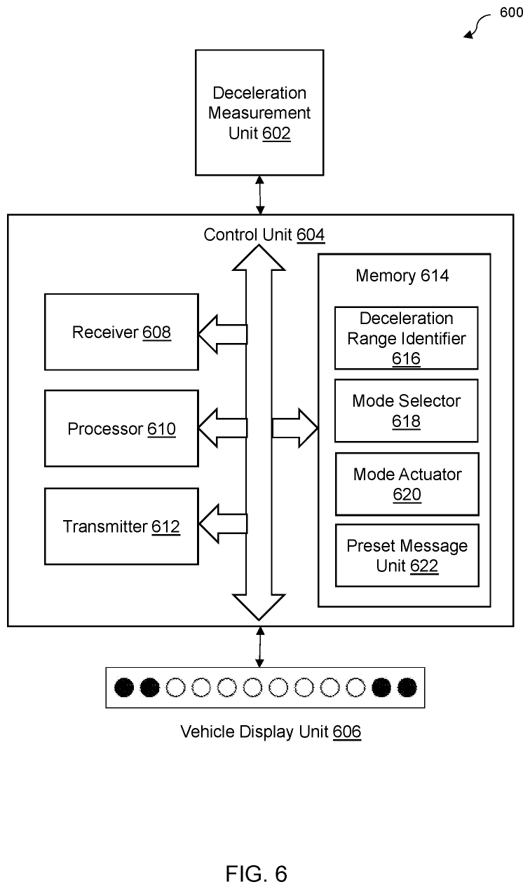

In accordance with an embodiment of the present disclosure, the vehicle display unit 202 is a part of a vehicle deceleration notification system that includes, apart from the vehicle display unit 102, a deceleration sensor/measurement unit and a control unit (as shown and described in FIG. 6). The deceleration sensor measures the magnitude of vehicle deceleration (whether achieved by brake pedal or not) of the first vehicle 102 and transmits the magnitude to the control unit. In other words, no reliance is made upon the depressing of the brake pedal, and the deceleration sensor detects the deceleration even if the brake pedal is not depressed.

In accordance with an embodiment of the present disclosure, the deceleration sensor may include, but is not limited to, an accelerometer, a wheel speed sensor, a gyro sensor, or any other braking sensor.

Further, as mentioned earlier, the vehicle display unit 202 and the control unit form an independent weatherproof, standalone design unit, which can be installed at the rear end of the first vehicle 102. For example, the vehicle display unit 202 and the control unit are installed either on the exterior between the taillights 204 or are mounted inside at the rear window area with a 12 volt power connection. The 12-volt power connection activates the vehicle display unit 202 and the control unit when the vehicle starts and deactivates them when the first vehicle 102 turns off Since the factory installed brake lights or taillights 204 function independently, no connection to the brake circuit of the first vehicle 102 is required for the operation of the vehicle display unit 202 and the control unit.

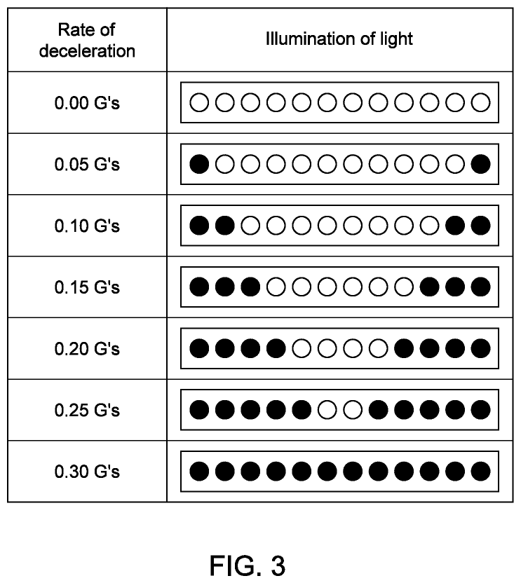

In response to receiving or obtaining the magnitude of vehicle deceleration from the deceleration sensor, the control unit actuates a number of LEDs of the plurality of LEDs installed in the vehicle display unit 202, in a predetermined manner. Specifically, the actuation of the plurality of LEDs may be based on the received magnitude of vehicle deceleration, such that the operator of the trailing vehicle is aware of the extent of deceleration of the first vehicle 102, which was not possible using the conventional brake warning lights. The details of the operation of the vehicle display unit 202 corresponding to the magnitude of vehicle deceleration of the first vehicle 102 may be understood in conjunction with FIG. 3.

FIG. 3 illustrates operation of the vehicle display unit 202 in accordance with the present disclosure. Specifically, FIG. 3 shows the different ways of illuminating the plurality of LEDs of the vehicle display unit 202 with respect to deceleration of the first vehicle 102.

In one or more embodiments, the deceleration sensor detects the magnitude of vehicle deceleration to be zero or negative when the first vehicle 102 is not moving or is accelerating. Hence, the control unit of the vehicle deceleration notification system does not actuate any LED on the vehicle display unit 202. The deceleration sensor detects the deceleration and measures the magnitude of vehicle deceleration when the first vehicle 102 starts to decelerate (whether achieved by braking or not). In response to detecting the deceleration, the deceleration sensor may transmit real-time magnitude of vehicle deceleration to the control unit. In response to receiving/obtaining the magnitude of vehicle deceleration, the control unit may progressively illuminate the plurality of LEDs based on the magnitude of vehicle deceleration. In other words, the control unit may illuminate each of the plurality of LEDs independently, thus producing the progressive smooth infilling effect of the vehicle display unit 202 as it reaches the point of completion.

In accordance with an embodiment of the present disclosure and as shown in FIG. 3, the plurality of LEDs actuates from the outer ends of the vehicle display unit 202 to the center, as the deceleration increases. Further, in accordance with an exemplary embodiment (as shown in FIG. 3) of the present disclosure, the vehicle display unit 202 may include 12 LEDs.

When there is no deceleration (e.g., zero or negative deceleration) the control unit does not actuate any LED of the plurality of LEDs. When the vehicle starts to decelerate, the control unit illuminates (actuates) the plurality of LEDs in a first display mode. In the first display mode, the plurality of LEDs progressively illuminates from the outer ends to the center of the vehicle display unit 202. For instance, 2 outer LEDs (one LED from the left side and one LED from the right side) may illuminate when the deceleration reaches 0.05 G. 4 LEDs (2 LEDs from the left side and 2 LEDs from the right side) may illuminate when the deceleration increases further and reaches 0.10 G. The system may illuminate 6 LEDs (3 LEDs from the left side and 3 LEDs from the right side) when the deceleration reaches a predetermined displacement force (e.g., 0.15 G). As the deceleration increases further (e.g., to 0.20 G), the system may cause 8 LEDs to illuminate, and at 0.25 G, the system may cause 10 LEDs to illuminate. All the 12 LEDs may illuminate when the deceleration reaches to 0.30 G. In other words, the plurality of LEDs progressively illuminates as the deceleration increases, and all the plurality of LEDs completely illuminate when the magnitude of vehicle deceleration reaches a first threshold (for example, 0.30 G). Specifically, the plurality of LEDs actuates progressively when the magnitude is in a first range (e.g., between 0 G to 0.30 G).

In accordance with an embodiment of the present disclosure, the plurality of LEDs extinguishes progressively in the reverse manner as they illuminated when the magnitude of vehicle deceleration starts to decrease. For instance, all the LEDs illuminate when the magnitude of vehicle deceleration is 0.30 G. The center 2 LEDs extinguish (e.g., 10 LEDs illuminate out of 12 LEDs) when the magnitude of vehicle deceleration decreases to 0.25 G. As the magnitude of vehicle deceleration decreases further to 0.20 G, the center 4 LEDs extinguish (e.g., 8 LEDs illuminate out of 12 LEDs), and so on until the magnitude of vehicle deceleration reaches zero at which point all the LEDs turn off

A person ordinarily skilled in the art may appreciate that the number of LEDs and the values of G, as mentioned above, are just examples and the present embodiment can work equally efficiently if the number of LEDs and/or the values of G are modified. Further, without departing from the scope of the present disclosure, the LEDs can progressively illuminate from the center of the vehicle display unit 202 to the ends and may not necessarily illuminate from the ends to the center as described above or as shown in FIG. 3.

In accordance with further embodiment of the present disclosure, the plurality of LEDs actuate in a second display mode as the magnitude of vehicle deceleration increases beyond the first threshold (e.g., beyond 0.30 G). In the second display mode, the plurality of LEDs actuates to maintain the complete illumination of all the LEDs until the magnitude of vehicle deceleration reaches a second threshold (such as 0.50 G). In other words, all the LEDs of the vehicle display unit 202 illuminate when the magnitude of vehicle deceleration is between the first threshold and the second threshold. Thus, the plurality of LEDs maintains complete illumination when the magnitude of the deceleration is in a second range (e.g., between 0.30 G to 0.50 G).

In accordance with further embodiment of the present disclosure, the plurality of LEDs may start to extinguish progressively in the reverse manner as they illuminated when the magnitude of vehicle deceleration decreases and falls below the first threshold (e.g., falls below 0.30 G), as discussed above. However, the plurality of LEDs maintains the complete illumination if the magnitude of vehicle deceleration is decreasing but it is still in the second range (e.g., between 0.30 G to 0.50 G). In other words, the plurality of LEDs may start to extinguish from the center to the outer ends of the vehicle display unit 202 only when the magnitude of vehicle deceleration decreases further and reaches the first range.

In accordance with further embodiment of the present disclosure, the plurality of LEDs may actuate in a third display mode (for example, an emergency braking condition mode) when the magnitude of vehicle deceleration increases beyond the second threshold (such as 0.50 G). In the third display mode, the plurality of LEDs actuates to progressively illuminate in one or more cycles repeatedly. The cycle of illumination may start from illumination of the plurality of LEDs at the outer ends to the center of the vehicle display unit 202, and end when all the plurality of LEDs extinguishes progressively from the center to the outer ends. In other words, the plurality of LEDs actuates to repeat one or more cycles of progressive illumination when the magnitude of vehicle deceleration is between the second threshold and a third threshold (for example, 0.7 G or 0.99 G or further) or in a third range. Thus, the plurality of LEDs repeats the cycle of progressive illumination when the magnitude of the deceleration is in the third range (e.g., between 0.50 G to 0.70 G or 0.99 G or further).

In accordance with further embodiment of the present disclosure, as the magnitude of vehicle deceleration decreases and falls below the second threshold (e.g., falls below 0.50 G), but is above the first threshold (e.g., above 0.30 G) or the magnitude of vehicle deceleration is in the second range, the plurality of LEDs may maintain complete illumination. The plurality of LEDs starts to extinguish progressively when the magnitude of vehicle deceleration decreases further and reaches the first range, as discussed above. The illumination of the light sources extinguishes completely as a magnitude of vehicle velocity approaches zero. In some aspects, the factory installed brake lights may function normally according to utilization of vehicle brakes, while the system causes a diminishing illumination effect as the rate of vehicle velocity changes (decreases). As the vehicle comes to a stop, the vehicle factory installed brake lights may illuminate normally, while the system causes the illumination effect to decrease to a non-illuminated state as the vehicle slows to a stop.

As mentioned earlier, the values of the first threshold (0.30 G), the second threshold (0.50 G), and the third threshold (0.70 G or 0.99 G) are mere examples, and any other values may also be used without departing from the scope of the present disclosure.

A person ordinarily skilled in the art may appreciate that the present disclosure is not limited to above-mentioned embodiments, but it may work in other embodiments as well. For instance, the vehicle display unit 202 may actuate in additional display modes as well. For example, in an additional display mode, the plurality of LEDs may illuminate in an alternate manner, e.g., one LED illuminates while the adjacent one stays in OFF mode. In accordance with an embodiment of the present disclosure, the control unit may actuate this display mode when the magnitude of vehicle deceleration goes beyond the third range.

Similarly, the control unit may actuate an additional display mode (for example, a Catastrophe mode or a fourth display mode) if the magnitude of vehicle deceleration reaches above a fourth threshold (such as 0.70 G) suddenly (such as, in 2 seconds) and is in a fourth range (for example, between 0.7 G to 0.99 G). In the fourth display mode, all the plurality of LEDs may actuate to simultaneously illuminate and maintain the complete illumination for a predetermined period (such as, 5 seconds). The maintaining of complete illumination for the predetermined period provides adequate warning of a looming catastrophic event to the operator of the trailing vehicle, even if the taillights 204 of the first vehicle I 02 do not illuminate. This scenario might happen when the operator of the first vehicle I 02 may not have time to depress the brakes suddenly.

In the embodiment mentioned above, the fourth range may overlap with the second range, or the third range, or beyond. However, the control unit may actuate the fourth display mode only when the rate of change of deceleration is greater than a predefined threshold. In other words, the deceleration should be sudden, for example, reaching a level of 0.7 Gin 2 seconds. Specifically, if the magnitude of vehicle deceleration reaches 0.7 Gin a progressive manner, then the control unit actuates the third display mode, however if the magnitude reaches to 0.7 G in 2 seconds, then the control unit actuates the fourth display mode.

To summarize, the different display modes of the vehicle display unit 202 may include the first display mode when the magnitude of vehicle deceleration is in the first range (for example, between 0 G to 0.3 G), the second display mode when the magnitude of vehicle deceleration is in the second range (for example, between 0.3 G to 0.5 G), the third display mode when the magnitude of vehicle deceleration is in the third range (for example, between 0.5 G to 0.7 G or 0.99 G), and the fourth display mode when the magnitude of vehicle deceleration is in the fourth range (for example, between 0.7 G to 0.99 G) and the rate of deceleration is greater than a predefined threshold (for example, reaching in the fourth range within 2 seconds).

In accordance with further embodiments of the present disclosure, the vehicle display unit 202 does not only provide indication of deceleration of the first vehicle 102, but may also provide other indications, for example for aesthetic purposes or to send out emergency warning signals. For instance, the plurality of LEDs of the vehicle display unit 202 may actuate to progressively illuminate in one or more cycles repeatedly for visual aesthetic purpose when the first vehicle 102 is keyed on. In this case, an observer may receive an indication that the vehicle is keyed on (starting).

Similarly, the vehicle display unit 202 may provide indication of change of one driving/performance mode to another driving/performance mode of the first vehicle 102. For instance, the plurality of LEDs of the vehicle display unit 202 may actuate to progressively illuminate in two or more cycles repeatedly for visual aesthetic purpose when the mode changes from the standard driving mode to the drag strip mode or Ludicrous mode. In this case, an observer may get an indication that the vehicle is now entering the drag strip high performance mode.

In accordance with yet another embodiment of the present disclosure, the vehicle display unit 202 may be pre-programmed to present/display various phrases or messages on the vehicle display unit 202. Specifically, as mentioned earlier, along with the plurality of LEDs, the vehicle display unit 202 may also include a computerized graphic display. In one or more embodiments, the vehicle display unit 202 may connect to an infotainment system (not shown in FIG. 2 or FIG. 3) of the first vehicle 102, which can enable the operator of the first vehicle 102 to select one or more preset phrases or messages, or type new personalized messages or designs to be displayed on the computerized graphic display of the vehicle display unit 202.

In the embodiment mentioned above, a memory of a vehicle deceleration notification system (as shown and described in FIG. 6) may store the preset phrases or messages. In response to receiving a request from the infotainment system, the vehicle deceleration notification system may transmit these preset phrases and messages to the infotainment system, so that the operator of the first vehicle 102 may view or select messages to display on the computerized graphic display. Alternatively, the operator of the first vehicle 102 may import preset phrases or messages from an external storage device, for example a USB flash drive, to the infotainment system of the first vehicle 102.

The vehicle display unit 202 displays the preset messages or designs, or personalized phrases, as mentioned above, when the first vehicle 102 is stationary or in a parking mode. Further, the operator of the first vehicle 102 can customize the cycles of illumination of the LEDs of the vehicle display 202, when the first vehicle 102 is stationary or in the parking mode.

In accordance with yet another embodiment of the present disclosure, the vehicle display unit 202 may display one or more of cycles of illumination of the LEDs, and/or personalized messages or images when an emergency signal of the first vehicle 102 is activated. For example, the personalized message may be “EMERGENCY” OR “HELP”. In this case as well, the vehicle display unit 202 works independently of the taillights 204 which typically flash when the emergency signal is activated.

The control unit of the vehicle deceleration notification system actuates the above-mentioned embodiments of displaying customized messages on the vehicle display unit 202 or customizing the cycles of illumination of LEDs of the vehicle display unit 202 when the first vehicle I 02 is in stationary or parking mode. The vehicle display unit 202 works as per the magnitude of vehicle deceleration and no customized or personalized messages are displayed when the first vehicle I 02 is in motion. This is done to avoid any distraction or confusion to the operator of the trailing vehicle.

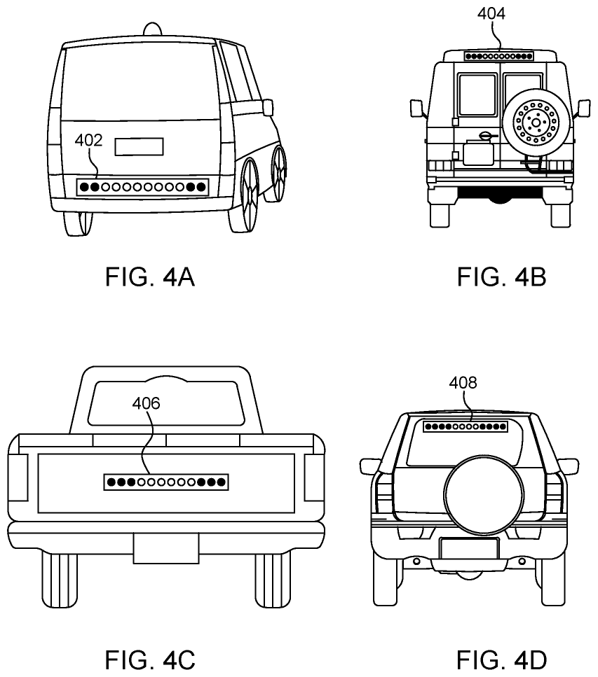

FIG. 4, specifically FIGS. 4a-4d depict exemplary embodiments of installation of the vehicle display unit 202 in accordance with the present disclosure. For instance, FIG. 4a depicts a first possible embodiment of the location of the vehicle display unit 402 on a vehicle. In this case, the vehicle display unit 402 is disposed closer to the bottom of the rear end of the vehicle. FIG. 4b depicts a second possible embodiment of the location of the vehicle display unit 404 on the vehicle. In the second embodiment, the vehicle display unit 404 is disposed near the top of the rear end of the vehicle. FIG. 4c depicts a third possible embodiment of the location of the vehicle display unit 406 on the vehicle. The third embodiment may be like the embodiments described in conjunction with FIGS. 1 and 2. FIG. 4d depicts a fourth possible embodiment of the location of the vehicle display unit 408 on the vehicle. In the fourth embodiment, the vehicle display unit 408 is disposed on the window (preferably on the inside of the window) at the rear end of the vehicle. The location of the vehicle display units 402, 404, 406, and 408 is based on the design of the vehicle and the space between the taillights. A person ordinary skilled in the art may appreciate that FIGS. 4a-4d are for illustrative purposes only and are not intended to be limiting or exclusive. For example, a vertical vehicle display unit may also be disposed at the rear end of the vehicle, without departing from the scope of the present disclosure.

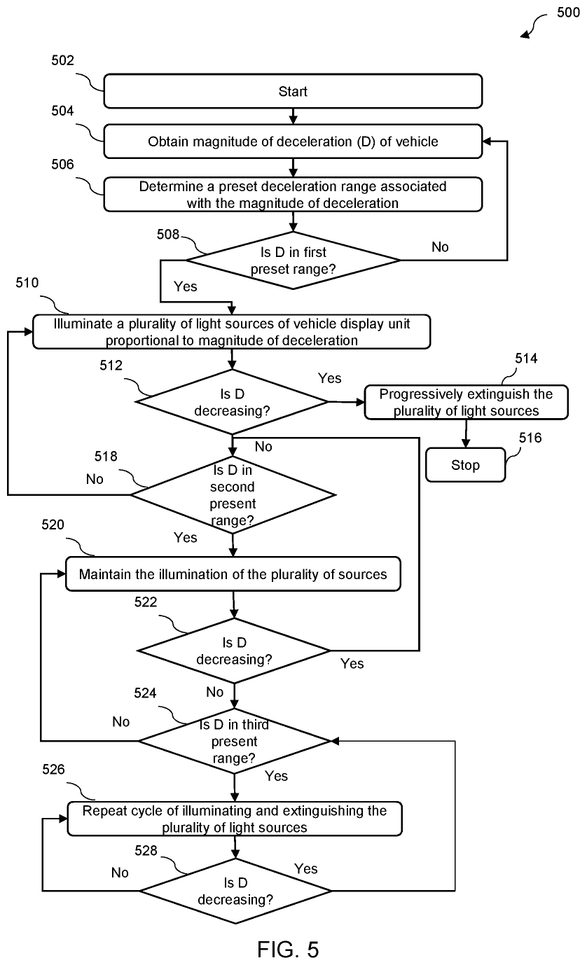

FIG. 5 is a flow diagram of an example method 500 for notifying deceleration of a vehicle, by a vehicle deceleration notification system, according to the present disclosure. FIG. may be described with continued reference to prior figures, including FIGS. 1-4. The following process is exemplary and not confined to the steps described hereafter. Moreover, alternative embodiments may include more or less steps that are shown or described herein and may include these steps in a different order than the order described in the following example embodiments.

Referring to FIG. 5, at step 502, the method 500 may commence. At step 504, the method includes obtaining, via the processor of the vehicle deceleration notification system, magnitude of vehicle deceleration. The processor obtains the magnitude of vehicle deceleration from a deceleration sensor installed in the vehicle. The deceleration sensor may include, but is not limited to, an accelerometer, a wheel speed sensor, a gyro sensor, or any other braking sensor. In accordance with an embodiment of the present disclosure, the deceleration sensor measures the magnitude of vehicle deceleration, and transmits the measured magnitude to the processor or a control unit installed in the vehicle. Once the processor receives the magnitude of vehicle deceleration, the method 500 proceeds to step 506.

At step 506, the method 500 may further include determining, via the processor, a preset deceleration range in which the magnitude of vehicle deceleration lies. In accordance with an embodiment of the present disclosure, there may be a plurality of preset deceleration ranges in which the magnitude of vehicle deceleration may lie. For instance, the plurality of preset deceleration ranges may include, but is not limited to, a first preset deceleration range (such as from 0 G to 0.30 G), a second preset deceleration range (such as from 0.30 G to 0.50 G), a third preset deceleration range (such as from 0.50 G to 0.70 G or 0.99 G or further), and so on.

In accordance with an embodiment of the present disclosure, in response to the determination of the preset deceleration range, the method 500 proceeds to selecting a display mode, of a plurality of display modes, of the vehicle display unit 202. Based on the selection of the display mode, the method 500 proceeds to actuating the selected display mode on the vehicle display unit 202. The details of the step of selecting and actuating may be understood in conjunction with the steps mentioned below.

In particular, at step 508, the method 500 may further include determining, via the processor, if the magnitude of vehicle deceleration (as received from the deceleration sensor) is in the first preset deceleration range. In other words, at step 508, the processor determines if the vehicle is decelerating, and the magnitude of vehicle deceleration is less than a first threshold (such as 0.30 G). If the processor determines that the magnitude of vehicle deceleration is not in the first preset deceleration range (which indicates that either the vehicle is stationary or it is accelerating), the method 500 moves back to the step 504 at which the processor again obtains the magnitude of vehicle deceleration in an iterative manner.

In a situation where the processor determines that the magnitude of vehicle deceleration lies in the first preset deceleration range (for example, between 0 to 0.30 G), the method 500 moves to step 510.

At step 510, the method 500 may further include illuminating, by the processor, a plurality of light sources, of the vehicle display unit 202 of the vehicle deceleration notification system, proportional to the magnitude of vehicle deceleration. In other words, at step 510, the method 500 includes actuating the plurality of light sources in a first display mode. In the first display mode, the plurality of light sources progressively actuates from the outer ends to the center of the vehicle display unit 202, as the deceleration increases, as mentioned in conjunction with FIG. 3.

At step 512, the method 500 may include determining, via the processor, if the magnitude of vehicle deceleration is decreasing. In other words, at step 512, the processor determines if the vehicle is accelerating, or the vehicle is further decelerating based on the obtained magnitude of vehicle deceleration from the deceleration sensor.

Based on a determination that the magnitude of vehicle deceleration is decreasing, the method 500 moves to step 514.

At step 514, the method 500 includes progressively extinguishing, via the processor, the plurality of light sources of the vehicle display unit 202 in the reverse manner as they were illuminated, as discussed in conjunction with FIG. 3. Once the magnitude of vehicle deceleration reaches zero, all the light sources extinguish, and the method 500 stops at step 516.

On the other hand, based on a determination that the magnitude of vehicle deceleration is increasing (at step 512), the method 500 moves to step 518. At step 518, the method 500 may further include determining, via the processor, if the magnitude of vehicle deceleration is in the second preset deceleration range. In other words, at step 518, the processor determines if the magnitude of the deceleration has increased beyond the first threshold (e.g., beyond 0.30 G) but is less than a second threshold (such as 0.50 G). If the processor determines that the magnitude of vehicle deceleration is not in the second preset deceleration range (which indicates that the magnitude of vehicle deceleration is still in the first preset deceleration range), the method 500 moves back to the step 510 at which the processor progressively illuminates the plurality of light sources proportional to the magnitude of vehicle deceleration.

In a situation where the processor determines that the magnitude of vehicle deceleration lies in the second preset deceleration range, the method 500 moves to step 520.

At step 520, the method 500 may further include maintaining, by the processor, complete illumination of the plurality of light sources of the vehicle display unit 202. In other words, at step 520, the method 500 includes actuating the plurality of light sources in a second display mode. In the second display mode, the plurality of light sources actuates to maintain the complete illumination until the magnitude of vehicle deceleration reaches the second threshold (such as 0.50 G). Thus, the plurality of light sources maintains complete illumination when the magnitude of the deceleration is in the second preset deceleration range (e.g., 0.30 G to 0.50 G), as mentioned in conjunction with FIG. 3.

At step 522, the method 500 includes determining, via the processor, if the magnitude of vehicle deceleration is decreasing. In other words, at step 522, the processor determines if the vehicle is accelerating, or the vehicle is further decelerating based on the obtained magnitude of vehicle deceleration from the deceleration sensor. Based on a determination that the magnitude of vehicle deceleration is decreasing, the method 500 moves to step 518, and determines, via the processor, whether the magnitude of vehicle deceleration is still in the second preset deceleration range. If the magnitude is still in the second preset deceleration range, then the method moves back to step 520 at which the plurality of light sources actuate to maintain the complete illumination.

If the magnitude of vehicle deceleration is decreasing and the magnitude of vehicle deceleration is not in the second preset deceleration range (which indicates that the magnitude of vehicle deceleration is in first preset deceleration range), the method 500 moves back to step 510.

Based on a determination that the magnitude of vehicle deceleration is increasing (at step 522), the method 500 moves to step 524. At step 524, the method 500 may further include determining, via the processor, if the magnitude of vehicle deceleration is in a third preset deceleration range. In other words, at step 524, the processor determines if the magnitude of the deceleration increases beyond the second threshold (e.g., beyond 0.50 G) but is less than a third threshold (such as 0.70 G or 0.99 G), e.g., between the third preset deceleration range of 0.5 G to 0.7 G or 0.99 G. If the processor determines that the magnitude of vehicle deceleration is not in the third preset deceleration range (which indicates that the magnitude of vehicle deceleration is still in the second preset deceleration range), the method 500 moves back to step 520 at which the processor maintains the illumination of the plurality of light sources.

In a situation where the processor determines that the magnitude of vehicle deceleration lies in the third preset deceleration range, the method 500 moves to step 526.

At step 526, the method 500 may further include repeating, by the processor, one or more cycles of progressive illumination of the plurality of light sources of the vehicle display unit 202. The cycle of illumination may start from illumination of the light sources at the outer ends to the center of the vehicle display unit 202, and end when all light sources extinguish progressively from the center to the outer ends. In other words, at step 526, the method 500 includes actuating the plurality of light sources in a third display mode. In the third display mode, the plurality of light sources actuates to repeat one or more cycle until the magnitude of vehicle deceleration reaches the third threshold (such as 0.70 G or 0.99 G). Thus, the plurality of light sources repeats the one or more cycles when the magnitude of vehicle deceleration is in the third preset deceleration range (e.g., 0.50 G to 0.70 G or 0.99 G), as mentioned in conjunction with FIG. 3.

At step 528, the method 500 includes determining, via the processor, if the magnitude of vehicle deceleration is decreasing. In other words, at step 528, the processor determines if the vehicle is accelerating, or the vehicle is further decelerating based on the obtained magnitude of vehicle deceleration from the deceleration sensor. Based on a determination that the magnitude of vehicle deceleration is decreasing, the method 500 moves to step 524, and determines, via the processor, whether the magnitude of vehicle deceleration is in the third preset deceleration range. If the magnitude of vehicle deceleration is decreasing and the magnitude of vehicle deceleration is not in the third preset deceleration range (which indicates that the magnitude of vehicle deceleration is in second preset deceleration range), the method 500 moves back to step 520. In a situation, where the magnitude of vehicle deceleration is increasing, the method 500 moves back to the step 526 at which the plurality of light sources actuate to repeat the one or more cycles.

The method 500 may include additional steps that are not depicted in FIG. 5. For example, the method 500 may include an additional step of determining, by the processor, whether the magnitude of vehicle deceleration is in a fourth preset deceleration range and the rate of change of deceleration is greater than a predefined threshold. Once it is determined by the processor that the magnitude of vehicle deceleration is in the fourth preset deceleration range and the rate of change of deceleration is greater than the predefined threshold, the processor may actuate a fourth display mode or a “Catastrophic” display mode of the vehicle display unit 202. In the fourth display mode, all the light sources of the vehicle display unit 202 actuate to simultaneously illuminate and maintain the complete illumination for a predetermined time (such as, 5 seconds). In accordance with an embodiment of the present disclosure, the fourth preset deceleration range may overlap with the second preset deceleration range or the third preset deceleration range, however the processor performs the steps 508-528 of FIG. 5 when the deceleration of the vehicle changes progressively or gradually, and the processor performs the additional step as mentioned here when the rate of change of deceleration is sudden. For instance, the processor performs the additional step when the magnitude of vehicle deceleration is in the fourth preset deceleration range (for example, between 0.7 gravitational constant (G) to 0.99 G) and the vehicle decelerates to the fourth preset deceleration range within a short, predefined time (for example, within 2 seconds).

The method 500 may include additional step of switching between the first display mode, the second display mode, the third display mode (and/or the fourth display mode), based on the magnitude of vehicle deceleration (and the rate of change of deceleration) of the vehicle.

FIG. 6 depicts a block diagram of a vehicle deceleration notification system 600 that may be installed in the first vehicle I 02, in accordance with the present disclosure. The vehicle deceleration notification system may include a deceleration measurement unit 602, a control unit 604, and a vehicle display unit 606, which are communicatively coupled to each other.

In accordance with an embodiment of the present disclosure, the deceleration measurement unit 602 may measure the magnitude of vehicle deceleration (whether achieved by brake activation or not) of the first vehicle 102. The deceleration measurement unit 602 may further transmit the magnitude of vehicle deceleration to the control unit 604. In accordance with an embodiment of the present disclosure, the deceleration measurement unit 602 may include, but is not limited to, an accelerometer, a wheel speed sensor, a gyro sensor, or any other braking sensor.

In accordance with an embodiment of the present disclosure, the vehicle display unit 606 may include a plurality of light sources, and functions independent of the factory installed brake lights or taillights of the first vehicle 102. The vehicle display unit 606 may be linearly or horizontally oriented, as shown in FIGS. 2 and 3. Furthermore, the vehicle display unit 606 may be a double mirrored display unit, so that it may present a double opposing linear mirrored image when the LEDs progressively illuminate. The details of the vehicle display unit 606 are already described in conjunction with previous figures.

In accordance with an embodiment of the present disclosure, the control unit 604 may include, in one example, a receiver 608, one or more processor(s) 610, a transmitter 612, and a computer-readable memory 614, which are communicatively coupled via control bus.

The control unit 604 may utilize the memory 614 to store programs in code and/or to store data for performing various vehicle deceleration notification operations in accordance with the disclosure. The memory 614 may be a non-transitory computer-readable memory. The processor(s) 610 may be configured and/or programmed to execute computer-executable instructions stored in the memory 614 for performing various functions of the control unit 604 as well as for performing vehicle deceleration notification capabilities in accordance with the disclosure. Consequently, the memory 614 may be used for storing code and/or data code and/or data for performing operations in accordance with the disclosure.

The one or more processor(s) 610 may be disposed in communication with one or more memory devices (e.g., the memory 614 and/or one or more external databases not shown in FIG. 6). The memory 614 may include any one or a combination of volatile memory elements (e.g., dynamic random-access memory (DRAM), synchronous dynamic random access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.

As mentioned earlier, the memory 614 may be one example of a non-transitory computer-readable medium and may be used to store programs in code and/or to store data for performing various operations in accordance with the disclosure. The instructions in the memory 614 can include one or more separate programs, each of which can include an ordered listing of computer-executable instructions for implementing logical functions.

Furthermore, the memory 614 may store various code modules such as, a deceleration range identifier 616, a mode selector 618, a mode actuator 620, and a preset message unit 622.

In accordance with an embodiment of the present disclosure, the receiver 608 may receive the magnitude of vehicle deceleration of the first vehicle 102 from the deceleration measurement unit 602. The magnitude of vehicle deceleration indicates whether the vehicle is decelerating or not (whether achieved by braking or not). In response to receiving the magnitude of vehicle deceleration, the receiver 608 may further store the magnitude of vehicle deceleration information in the memory 614.

In accordance with an embodiment of the present disclosure, when the receiver 608 receives the magnitude of vehicle deceleration from the deceleration measurement unit 602 and stores it in the memory 614, the processor 610 obtains the magnitude of vehicle deceleration from the memory 614. In response to obtaining, the processor 610 transmits a command to the deceleration range identifier 616 of the memory 614 to determine a preset deceleration range, of a plurality of preset deceleration ranges, associated with the received magnitude of vehicle deceleration. For instance, the plurality of preset deceleration ranges may include, but is not limited to, a first preset deceleration range (such as from 0 G to 0.30 G), a second preset deceleration range (such as from 0.30 G to 0.50 G), a third preset deceleration range (such as from 0.50 G to 0.7 G or 0.99 G), and so on.

In response to determining the preset deceleration range, the processor 610 may transmit a command to the mode selector 618 to select a display mode of a plurality of display modes, of the vehicle display unit 606. In accordance with further embodiment of the present disclosure, the processor 610 may transmit a command to the mode actuator 620 to actuate the selected display mode of the vehicle display unit 606.

In accordance with an embodiment of the present disclosure, the plurality of display modes may include a first display mode in which the plurality of light sources of the vehicle display unit 606 actuate to progressively illuminate, from the outer ends to the center of the vehicle display unit 606, proportional to the magnitude of vehicle deceleration. The mode actuator 620 may actuate the first mode when the magnitude of vehicle deceleration is in a first preset deceleration range of the plurality of preset deceleration ranges.

The plurality of display modes may further include a second display mode in which the plurality of light sources actuates to maintain complete illumination of the plurality of light sources of the vehicle display unit 606. The mode actuator 620 may actuate the second display mode when the magnitude of vehicle deceleration increases beyond the first preset deceleration range and is in a second preset deceleration range of the plurality of preset deceleration ranges.

The plurality of display modes may include a third display mode in which the plurality of light sources actuates to progressively illuminate in one or more cycles repeatedly. A cycle of illumination may start from illumination of the light sources at the outer ends to the center of the vehicle display unit 606, and end when all light sources extinguish progressively from the center to the outer ends. The mode actuator 620 may actuate the third display mode when the magnitude of vehicle deceleration is in a third preset deceleration range, of the plurality of preset deceleration ranges, and the third preset deceleration range is greater than the second preset deceleration range.

As described in conjunction with FIGS. 3 and 5, the mode actuator 620 may also actuate a fourth display mode, which is the catastrophic display mode. In the fourth display mode, the plurality of light sources actuates to simultaneously illuminate and maintain the complete illumination for a predetermined time duration. The mode actuator 620 actuates the fourth display when the magnitude of vehicle deceleration reaches a fourth preset deceleration range, of the plurality of preset deceleration ranges, and a rate of change of deceleration is greater than a predefined threshold. As already described earlier, the fourth preset deceleration range may overlap with the second preset deceleration range or the third preset deceleration range, however the mode actuator 620 actuates the fourth display mode when the rate of deceleration of the first vehicle 102 is greater than a predefined threshold (e.g., reaching to a level of 0.7 G in 2 seconds).

In accordance with further embodiment of the present disclosure, the processor 610 is may transmit a command to the mode actuator 620 to progressively extinguish the illumination of the plurality of light sources as the magnitude of vehicle deceleration decreases. The illumination of the light sources of the vehicle display unit 606 extinguishes completely as the magnitude of vehicle deceleration of the first vehicle 102 reaches zero. The details of the extinguishing the plurality of light sources are already described in conjunction with the previous figures. In addition, the processor 610 may transmit a command to the mode actuator 620 to switch between the first display mode, the second display mode, the third display mode, and the fourth display mode based on the change in the magnitude of the deceleration (and the rate of change of deceleration for the fourth mode).

In accordance with the further embodiment of the present disclosure, the processor 610 may command the mode actuator 620 to actuate the vehicle display unit 606 to progressively illuminate in one or more cycles repeatedly when the vehicle is starting. Similarly, the processor 610 may command the mode actuator 620 to actuate the vehicle display unit 606 to progressively illuminate in two or more cycles repeatedly when the vehicle is switching from one driving mode to another driving mode. The details of the actuation of the vehicle display unit 606 when the vehicle is starting or when the driving mode is switching are already described in conjunction with the previous figures.

In accordance with an additional embodiment of the present disclosure, the processor 610 may transmit a command to the preset message unit 622 to fetch preset messages from the memory 614 and display the preset messages on an infotainment system (not shown in FIG. 6, and not a part of the vehicle deceleration notification system 600) of the first vehicle 102 when the first vehicle 102 is stationary. Specifically, as already mentioned in conjunction with FIG. 3, along with the plurality of light sources (for example, LEDs), the vehicle display unit 606 may also include a computerized graphic display (not shown in FIG. 6) which may display customized messages or phrases or images on the vehicle display unit 606. In accordance with the present embodiment, the preset message unit 622 stores said preset messages that may be used by the operator to select and display on the vehicle display unit 606. In addition, the preset message unit 622 may receive customized messages from the operator and store them in the memory 614. For example, the operator may type the customized message on the infotainment system of the first vehicle 102 and may save it for future use. Alternatively, the operator may transfer customized messages from an external memory device, for example USB flash drive, to the information system. The infotainment system may send the typed or the transferred customized messages to the control unit 604, which in turn stores the messages in the preset message unit 622 of the memory 614. Thereafter, as and when the operator of the first vehicle 102 wishes to display a customized or preset message on the computerized graphic display, the operator can select a message on the information system (which is fetched from the preset message unit 622) and send a command to the control unit 604 of the vehicle deceleration notification system 600 to display the selected message on the computerized graphic display of the vehicle display unit 606.

As already mentioned in conjunction with FIG. 3, the vehicle display unit 606 displays the customized or preset messages when the first vehicle I 02 is stationary, and not when the first vehicle I 02 is in motion.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

Regarding the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method for notifying deceleration of a vehicle, the method comprising:
obtaining, via a processor of a vehicle deceleration notification system, a magnitude of vehicle deceleration;
determining, via the processor, a preset deceleration range, of a plurality of preset deceleration ranges, associated with the magnitude of vehicle deceleration;
selecting, via the processor, a display mode of a plurality of display modes, of a vehicle display unit installed at rear end of the vehicle, based on the determination, wherein the vehicle display unit is a linearly oriented and double mirrored display unit comprising a plurality of light sources;
actuating, via the processor, the selected display mode of the vehicle display unit, wherein the plurality of display modes comprises:
a first display mode in which the plurality of light sources are actuated to progressively illuminate, from outer ends of the vehicle display unit to center of the vehicle display unit, proportional to the magnitude of vehicle deceleration, wherein the first display mode is actuated when the magnitude of vehicle deceleration is in a first preset deceleration range of the plurality of preset deceleration ranges;
a second display mode in which the plurality of light sources are actuated to maintain complete illumination, wherein the second display mode is actuated when the magnitude of vehicle deceleration increases beyond the first preset deceleration range and is in a second preset deceleration range of the plurality of preset deceleration ranges; and
a third display mode in which the plurality of light sources are actuated to simultaneously illuminate and maintain the complete illumination for a predetermined time duration, wherein the third display mode is actuated when the magnitude of vehicle deceleration reaches a third preset deceleration range, of the plurality of preset deceleration ranges, and a rate of change of deceleration is greater than a predefined threshold.

2. The method of claim 1, wherein the vehicle display unit is installed between factory installed brake lights of the vehicle.

3. The method of claim 2, wherein an illumination level of the vehicle display unit is same as an illumination level of the factory installed brake lights.

4. The method of claim 2, wherein the vehicle display unit functions independent of the factory installed brake lights.

5. The method of claim 1, wherein actuating the display mode further comprises progressively extinguishing, via the processor, the illumination of the plurality of light sources as the magnitude of vehicle deceleration decreases, wherein the illumination extinguishes completely as a magnitude of vehicle velocity approaches zero.

6. The method of claim 1, wherein actuating the display mode further comprises switching, via the processor, between the first display mode, the second display mode, and the third display mode, based on the change in the magnitude of the deceleration.

7. The method of claim 1, wherein the plurality of display modes comprises a fourth display mode, in which the plurality of light sources are actuated to progressively illuminate in one or more cycles repeatedly, wherein a cycle of illumination starts from illumination of the light sources at the outer ends to the center, and ends when all light sources of the plurality of light sources are extinguished progressively from the center to the outer ends,
wherein the fourth display mode is actuated when the magnitude of vehicle deceleration is in a fourth preset deceleration range, of the plurality of preset deceleration ranges, and wherein the fourth preset deceleration range is greater than the second preset deceleration range.

8. A vehicle deceleration notification system comprising:
a deceleration sensor installed in a vehicle, the deceleration sensor is configured to measure magnitude of vehicle deceleration;
a vehicle display unit installed at a rear end of the vehicle, wherein the vehicle display unit is a linearly oriented and double mirrored display unit comprising a plurality of light sources;
a processor communicatively coupled to the deceleration sensor r and the vehicle display unit, the processor is configured to:
obtain the magnitude of vehicle deceleration from the deceleration sensor;
determine a preset deceleration range, of a plurality of preset deceleration ranges, associated with the magnitude of vehicle deceleration;
select a display mode of a plurality of display modes, of the vehicle display unit based on the determination of the associated preset deceleration range; and
actuate the selected display mode of the vehicle display unit, wherein the plurality of display modes comprises:
a first display mode in which the plurality of light sources are actuated to progressively illuminate, from outer ends of the vehicle display unit to center of the vehicle display unit, proportional to the magnitude of vehicle deceleration, wherein the first display mode is actuated when the magnitude of vehicle deceleration is in a first preset deceleration range of the plurality of preset deceleration ranges;
a second display mode in which the plurality of light sources are actuated to maintain complete illumination, wherein the second display mode is actuated when the magnitude of vehicle deceleration increases beyond the first preset deceleration range and is in a second preset deceleration range of the plurality of preset deceleration ranges; and
a third display mode in which the plurality of light sources are actuated to simultaneously illuminate and maintain the complete illumination for a predetermined time duration, wherein the third display mode is actuated when the magnitude of vehicle deceleration reaches a third preset deceleration range, of the plurality of preset deceleration ranges, and a rate of change of deceleration is greater than a predefined threshold.

9. The vehicle deceleration notification system of claim 8, wherein the vehicle display unit is installed between factory installed brake lights of the vehicle.

10. The vehicle deceleration notification system of claim 9, wherein an illumination level of the vehicle display unit is same as an illumination level of the factory installed brake lights.

11. The vehicle deceleration notification system of claim 9, wherein the vehicle display unit functions independent of the factory installed brake lights.

12. The vehicle deceleration notification system of claim 8, wherein the processor is further configured to progressively extinguish the illumination of the plurality of light sources as the magnitude of vehicle deceleration decreases, and extinguish the illumination completely as a magnitude of vehicle velocity approaches zero.

13. The vehicle deceleration notification system of claim 8, wherein the processor is further configured to switch between the first display mode, the second display mode, and the third display mode, based on the change in the magnitude of the deceleration.

14. The vehicle deceleration notification system of claim 8, wherein the plurality of display modes further comprises a fourth display mode, in which the plurality of light sources are configured to progressively illuminate in one or more cycles repeatedly, wherein a cycle of illumination starts from illumination of the light sources at the outer ends to the center, and ends when all light sources of the plurality of light sources are extinguished progressively from the center to the outer ends,
wherein the fourth display mode is actuated when the magnitude of vehicle deceleration is in a fourth preset deceleration range, of the plurality of preset deceleration ranges, and wherein the fourth preset deceleration range is greater than the second preset deceleration range.

15. A non-transitory computer-readable storage medium having instructions stored thereupon which, when executed by a processor, cause the processor to:
obtain a magnitude of vehicle deceleration from a deceleration sensor;
determine a preset deceleration range, of a plurality of preset deceleration ranges, associated with the magnitude of vehicle deceleration;
select a display mode of a plurality of display modes, of a vehicle display unit based on the determination of the associated preset deceleration range; and
actuate the selected display mode of the vehicle display unit, wherein the plurality of display modes comprises:
a first display mode in which a plurality of light sources are actuated to progressively illuminate, from outer ends of the vehicle display unit to center of the vehicle display unit, proportional to the magnitude of vehicle deceleration, wherein the first display mode is actuated when the magnitude of vehicle deceleration is in a first preset deceleration range of the plurality of preset deceleration ranges;
a second display mode in which the plurality of light sources are actuated to maintain complete illumination, wherein the second display mode is actuated when the magnitude of vehicle deceleration increases beyond the first preset deceleration range and is in a second preset deceleration range of the plurality of preset deceleration ranges; and
a third display mode in which the plurality of light sources are actuated to simultaneously illuminate and maintain the complete illumination for a predetermined time duration, wherein the third display mode is actuated when the magnitude of vehicle deceleration reaches a third preset deceleration range, of the plurality of preset deceleration ranges, and a rate of change of deceleration is greater than a predefined threshold.

16. The non-transitory computer-readable storage medium according to claim 15, wherein the vehicle display unit is installed between factory installed brake lights of a vehicle.

17. The non-transitory computer-readable storage medium according to claim 16, wherein an illumination level of the vehicle display unit is same as an illumination level of the factory installed brake lights.

18. The non-transitory computer-readable storage medium according to claim 16, wherein the vehicle display unit functions independent of the factory installed brake lights.

19. The non-transitory computer-readable storage medium according to claim 15, having further instructions stored thereupon to progressively extinguish the illumination of the plurality of light sources as the magnitude of vehicle deceleration decreases, and extinguish the illumination completely as a magnitude of vehicle velocity approaches zero.

20. The non-transitory computer-readable storage medium according to claim 15, wherein the plurality of display modes further comprises a fourth display mode, in which the plurality of light sources are configured to progressively illuminate in one or more cycles repeatedly, wherein a cycle of illumination starts from illumination of the light sources at the outer ends to the center, and ends when all light sources of the plurality of light sources are extinguished progressively from the center to the outer ends,
wherein the fourth display mode is actuated when the magnitude of vehicle deceleration is in a fourth preset deceleration range, of the plurality of preset deceleration ranges, and wherein the fourth preset deceleration range is greater than the second preset deceleration range.
